(19) United States
(12) Patent Application Publication
(10) Pub. No.: US 2025/0045070 A1
(43) Pub. Date: Feb. 6, 2025

(54) HEURISTIC DATA PIPELINE SCHEDULING

(71) Applicant: Kyndryl, Inc., New York, NY (US)

(72) Inventors: Madhusoodanan K. Madhavan, Bangalore (IN); Anil Babu Boppanna, Bangalore (IN); Aman Agarwal, Imphal (IN); Siddesh L. Gad, Ponda (IN)

(21) Appl. No.: 18/228,401

(22) Filed: Jul. 31, 2023

(51) Int. Cl. G06F 9/448

(52) U.S. Cl. CPC G06F 9/4494

(57) ABSTRACT

A computer-implemented method, including: receiving, by a computing device, a data pipeline job request; generating, by the computing device, a complexity score for the data pipeline job request; determining, by the computing device, a predicted execution time for the data pipeline job request; generating, by the computing device, a priority score for the data pipeline job request based on the predicted execution time and the generated complexity score; and comparing, by the computing device, the priority score for the data pipeline job request to another priority score to determine a schedule for the data pipeline job request.

### BACKGROUND

Aspects of the present invention relate generally to data pipeline management and, more particularly, to scheduling of data pipelines for optimal resource usage and data freshness.

### SUMMARY

In a first aspect of the invention, there is a computer-implemented method including: receiving, by a computing device, a data pipeline job request; generating, by the computing device, a complexity score for the data pipeline job request; determining, by the computing device, a predicted execution time for the data pipeline job request; generating, by the computing device, a priority score for the data pipeline job request based on the predicted execution time and the generated complexity score, and comparing, by the computing device, the priority score for the data pipeline request to another priority score to determine a schedule for the data pipeline job request.

In another aspect of the invention, there is a computer program product including one or more computer readable storage media having program instructions collectively stored on the one or more computer readable storage media. The program instructions are executable to: receive a data pipeline job request; generate a complexity score for the data pipeline job request; determine a predicted execution time for the data pipeline job request; generate a priority score for the data pipeline job request based on the predicted execution time and the generated complexity score; and compare the priority score for the data pipeline job request to another priority score to determine a schedule for the data pipeline job request. The predicted execution time is determined by utilizing a machine learning model trained with pipeline information of historical data pipeline jobs.

In another aspect of the invention, there is system including a processor, a computer readable memory, one or more computer readable storage media, and program instructions collectively stored on the one or more computer readable storage media. The program instructions are executable to: receive a plurality of data pipeline job requests; generate a complexity score for each of the data pipeline job requests; determine a predicted execution time for each of the data pipeline job requests; generate a priority score for each of the data pipeline job requests based on the predicted execution time and the generated complexity score; and compare the priority score for each of the data pipeline job requests to another priority score to determine a schedule for each of the data pipeline job requests.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary data pipeline management environment in accordance with aspects of the present invention.

FIG. 5 shows a flowchart of objects and steps taken of an exemplary method in accordance with aspects of the present invention.

FIG. 6 shows a chart of a smart scheduler prioritization of data pipelines of an exemplary method in accordance with aspects of the present invention.

FIG. 7 shows a flowchart of an exemplary method in accordance with aspects of the present invention.

### DETAILED DESCRIPTION

Aspects of the present invention relate generally to data pipeline management and, more particularly, to scheduling of data pipelines. In this manner, implementations of the invention provide optimal resource usage and data freshness. For example, scheduling a data pipeline utilizes a complexity scoring, execution time prediction, and priority scoring to create a data pipeline management system. Accordingly, scheduling of the data pipeline may utilize a low amount of resources while still managing workload variability, enabling graceful degradation during overloaded periods, minimizing manual intervention and automation of restart/reprioritization of data pipelines, reducing warmup time based on forecasted usage predictions, and identifying data pipelines for prioritization.

Implementations of the invention include a method, system, and computer program product for identifying an optimal data pipeline execution plan based on an execution time and environmental factors. For example, environmental factors may include varying data sizes, varying complexity of data transformations of the data pipelines, network latency, and varying workloads at data sources and client systems, which compete for runtime resources. Thus, in embodiments, the execution plan ensures optimal resource usage and data freshness by utilizing a machine learning model based on historical data. The machine learning model utilizes a smart scheduler to ensure optimal resource usage and data freshness. The smart scheduler utilizes predetermined factors to determine the schedule for the data pipelines. In embodiments, the predetermined factors may include a complexity score, execution time prediction, and a priority score. The complexity scoring provides a scale for assessing the complexity of a defined data pipeline. The execution time prediction also utilizes artificial intelligence (AI) based execution time predictors to aid in prioritizing data pipeline jobs. The complexity score and execution time prediction are utilized in generating a priority score of each data pipeline job. The priority score is dynamically generated to account for changes in resource usage and data freshness.

Implementations of the invention provide an improvement in the technical field of data pipeline management by providing a technical solution to the problem of over allocation of resources and issues with data pipeline job completion that may result in missing service level agreement (SLA) terms and increased operational costs. For example, in embodiments, the computer-implemented method may include, amongst other features: receiving a data pipeline job request; generating a complexity score for the data pipeline job request; determining a predicted execution time for the data pipeline job request; and generating a priority score for the data pipeline job request based on the predicted execution time and the complexity score, the priority scores being utilized to schedule the data pipeline job request. These steps allow the data pipeline manager to improve schedule data pipeline jobs to optimally utilize resources without over allocation and efficiently provide fresh data to client data pipeline requests.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

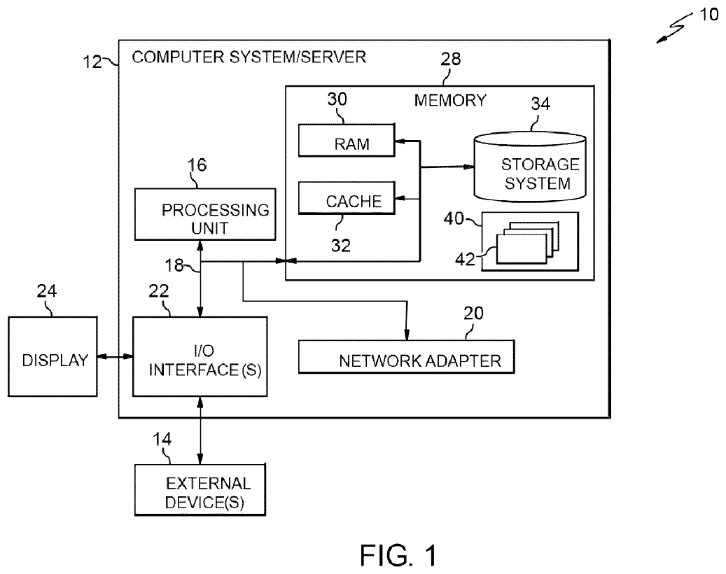

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

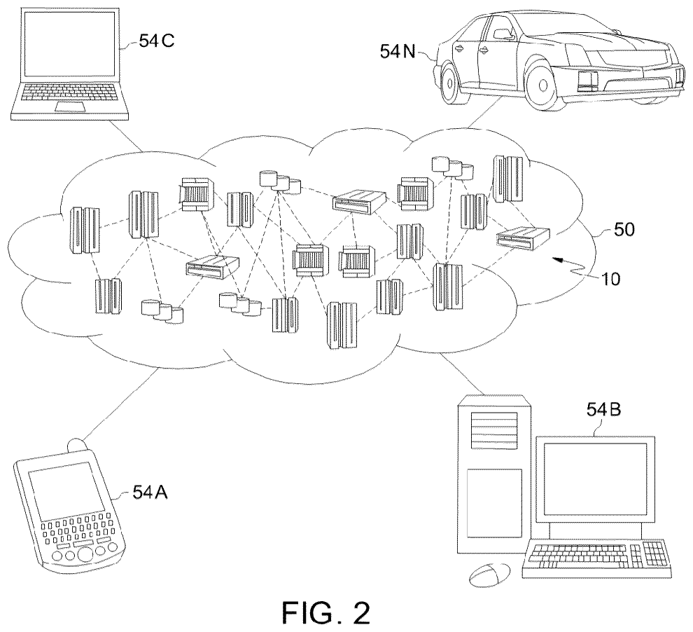

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

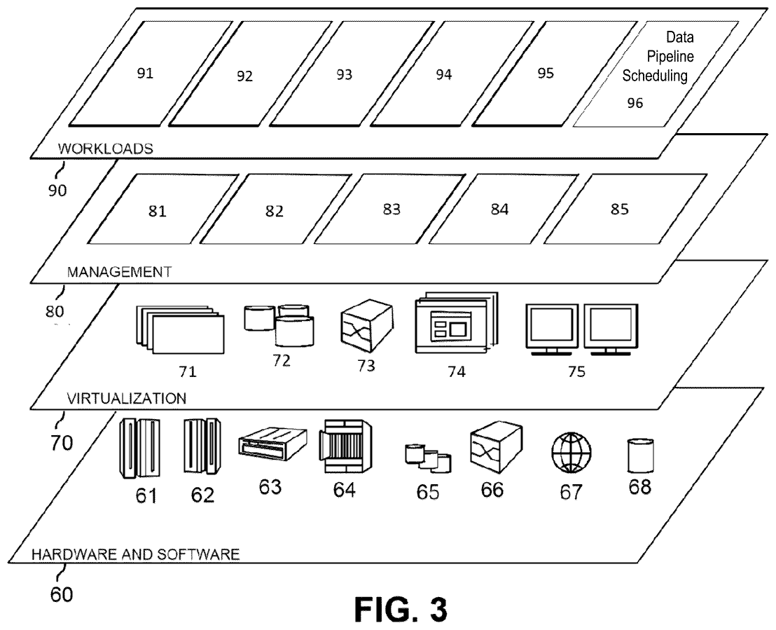

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data pipeline scheduling 96.

Implementations of the invention may include a computer system/server 12 of FIG. 1 in which one or more of the program modules 42 are configured to perform (or cause the computer system/server 12 to perform) one of more functions of the data pipeline scheduling 96 of FIG. 3. For example, the one or more of the program modules 42 may be configured to, amongst other features: (i) receive data pipeline job requests; (ii) generate a complexity score for each of the data pipeline job requests; (iii) determine a predicted execution time for each of the data pipeline job requests; (iv) generate a priority score for each of the data pipeline job requests based on the predicted execution time and the generated complexity score; and (v) compare the priority score for each of the data pipeline job requests to another priority score determine a schedule for each of the data pipeline job requests.

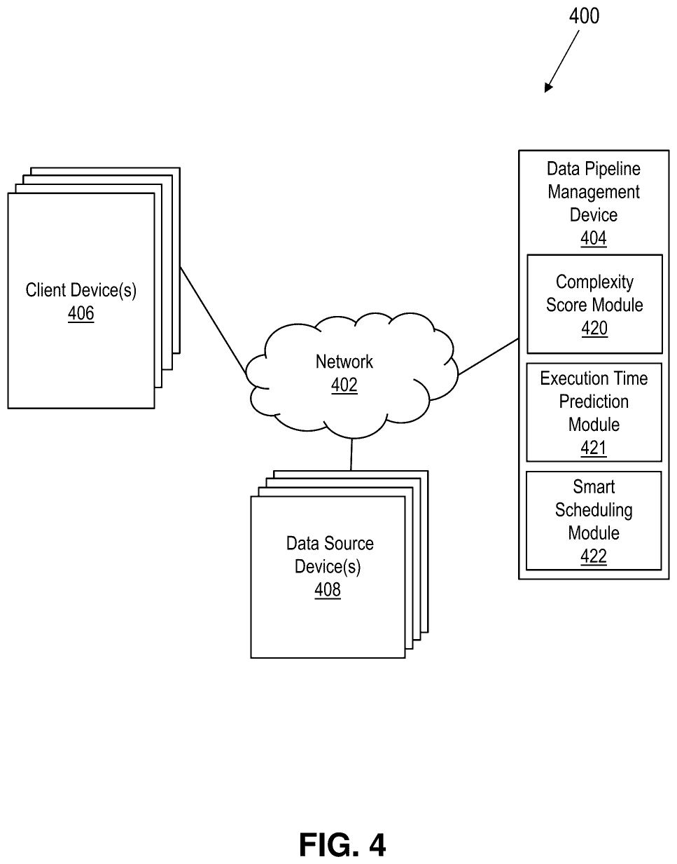

FIG. 4 shows a block diagram of an exemplary data pipeline management environment in accordance with aspects of the present invention. In embodiments, the data pipeline management environment 400 includes a network 402 enabling communication between data pipeline management device 404, client device(s) 406, and data source device(s) 408. In embodiments, the data pipeline management device 404, the client device(s) 406, and the data source device(s) 408 may each comprise a computing device (e.g., the computer system/server 12 of FIG. 1, or elements therefor) in the network 402 and/or a computing node 10 in the cloud computing environment 50 of FIG. 2 and/or one or more program modules such as program modules 42 described with respect to FIG. 1.

In embodiments of FIG. 4, the client device(s) 406 may request data pipeline job(s) from the data pipeline management device 404. The data pipeline management device 404 may be a platform (i.e., one or more server computing devices) that hosts the execution of the data pipeline(s). The client device(s) 406 may register the data pipeline job(s) with the data pipeline management device 404 to define and provide the state of the data pipeline for consideration pipeline management device 404. The data source device(s) 408 includes one or more computing devices (i.e., one or more server computing devices) hosting data that will be utilized by the data pipeline through ingestion (i.e., collection), transformation, or storing.

In embodiments of FIG. 4, the data pipeline management device 404 comprises a complexity score module 420, execution time prediction module 421, and smart scheduling module 422, each of which may comprise one or more program modules such as program modules 42 described with respect to FIG. 1. The data pipeline management device 404 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments of FIG. 4, the complexity score module 420 is configured to calculate a data pipeline complexity score (hereinafter the “complexity score”) for each data pipeline. The data pipeline management device 404 is configured to manage each data pipeline. In an exemplary embodiment, the complexity score is calculated by considering both a static analysis and runtime analysis of the data pipeline.

In embodiments, the static analysis of the data pipeline is represented by a static analysis score. The static analysis score is calculated based on a sum of the product of the count of significant patterns and weighting of each significant pattern type. In embodiments, significant patterns include a list of identified tokens of the data pipeline and curated by subject matter experts based on optimization of data pipeline scripts. For example, the static analysis may be represented by a score calculated as shown in formula (i) below:

$${\sum }_{i = 0}^{n} {SP}_{i} ( count ) * {SP}_{i} ( weighting ) \qquad ( i )$$

$${SP}_{i} = Significant Pattern of a Data Pipeline$$

Significant patterns may include steps to utilize data from a data source device to a client device. In embodiments, the significant patterns fall under three core steps including: data ingestion (i.e., collecting data from data source device), transformation of the data (i.e., processing of the data from the data source device), and data storage (i.e., storing the transformed data in a data repository). Each core step may include many exemplary significant patterns and weightings as shown in Table 1 below. In particular, in embodiments, the significant patterns include different types of data ingestion, data transformation, and data storage.

TABLE 1
Significant Pattern Weighting Based
on the Significant Pattern Type

| Significant Pattern | Weighting |
|---|---|
| Shuffling/Sorting | 0.8 |
| De-duplication | 0.6 |
| Regular Expression Search | 0.5 |
| (Regex) of Text | |
| Input-Output/Read-Write | 0.5 |
| Aggregation | 0.4 |
| Serverless Function | 0.2 |

In Table 1 above, the weighting of the indicated significant patterns is initially determined by a subject matter expert. However, in exemplary embodiments, the weighting may be adjusted to fit the utilization and needs of a data pipeline management platform. Each data pipeline may utilize any number of significant patterns of any significant pattern type. For example, a data pipeline may include five steps of sorting of data, one step of de-duplication, and two steps of aggregation. Each of these significant patterns or subsets of these significant patterns including its own weighting.

Additionally, in embodiments of FIG. 4, a runtime analysis of the data pipeline is represented by a runtime analysis score. The runtime analysis score is calculated at the end of execution of the data pipeline from the count of dominant data pipeline execution profiles and actual resources spent. For example, the runtime analysis score is the sum of a count (e.g., top 80% of a cumulative time spent executing the data pipeline from the data pipeline execution profile), central processing unit resources (e.g., virtual central processing unit(s) per millisecond (vCPUs/ms)), memory usage (e.g., in megabytes (MBs)), network utilization/file input-output (IO) (e.g., megabytes per millisecond (MBs/ms)) per number of records processed.

In embodiments of FIG. 4, as more historical data is collected regarding the complexity scores for each data pipeline, changes to the system may be made to increase the calculation efficiency. For example, once a sufficient amount of data is collected and provides consistent results, dimensionality reduction techniques may be utilized to derive the complexity score. For example, a principal component analysis (PCA) may be utilized with the same significant patterns in a lower-dimensional space.

In embodiments of FIG. 4, the execution time prediction module 421 is configured to utilize artificial intelligence (AI) and machine learning (ML) models to predict the time taken to execute a data pipeline. In embodiments, the ML model is a regression model which receives many training inputs. The training inputs may include data pipeline information that contributes to the execution time, including, but not limited to one or more of: a pipeline name of a data pipeline, timestamp of the data pipeline, a type of data pipeline (e.g., streaming/batch), resources requirement needed to execute the data pipeline, time to live, initial timestamp of a data request of a data pipeline job, a predicted execution time of the data pipeline, complexity score of the data pipeline received from the complexity score module 420, a type of data source of the data pipeline, priority of the data pipeline, and network requirement.

In embodiments, the smart scheduling module 422 is configured to schedule the data pipelines based on a priority scoring of each of the data pipelines. In embodiments, the priority scoring is determined based on various inputs including inputs from both the complexity score module 420 and execution time prediction module 421. Further, the priority scoring may additionally account for other additional inputs such as resource requirements for each of the data pipelines. For example, the priority score may be calculated through a summation of these key factors as shown in formula (ii) below

$$P = {\sum }_{i = 0}^{n} {SP}_{i} ( count ) * {SP}_{i} ( weighting ) + CPU and Memory Allocation + EET$$

$${SP}_{i} = Significant Pattern of a Data Pipeline$$

$$CPU = CPU allocated to \text{execute/complete} the data pipeline job ( e . g . , vCPUs / ms )$$

$$Memory = Memory allocated to \text{execute/complete} the data pipeline job ( e . g . , MBs )$$

$$EET = Estimate execution time of data pipeline ( e . g . , mins . )$$

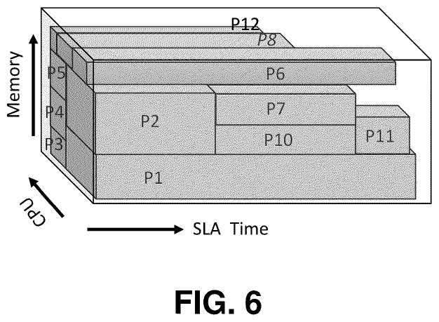

In embodiments, the service level agreement (SLA) terms (e.g., the SLA time) may be an additional input to reduce the potential for breach of the SLA terms. In embodiments, the smart scheduling module 422 utilizes a reinforcement learning model that includes the historical data pipeline information, such as similar information utilized by the execution time prediction module 421 and includes one or more of: the name of a data pipeline, types of data, resource requirements, and time to live to track and update known historical data pipelines and the resource usage. In embodiments, the smart scheduler module 422 generates a visual representation of the scheduled data pipelines in a rectangular prism as shown in FIG. 6. The axes of the rectangular prism represent the estimated resource requirements of each data pipeline and are organized so that data pipelines with higher priority scores are stacked over another to optimally utilize the predetermined resource allocations available to the data pipeline management device 404. For example, the data pipeline management device 404 may utilize a bank of servers (or other computer devices) to execute the data pipelines. In particular, resources available to the bank of servers may be limited to x CPU and y Memory and a max utilization rate of 80%. Thus, the resource allocation for execution of the data pipeline jobs may be calculated as x*0.8 vCPUs/ms and y*0.8 MBs. Also, each data pipeline may have an SLA time. The data pipeline jobs with SLA times may retain priority over those data pipeline jobs that do not have SLA times. This allows for the prevention of SLA term breaches. In an example, data pipelines earliest on the SLA time axis may have the highest priority scores.

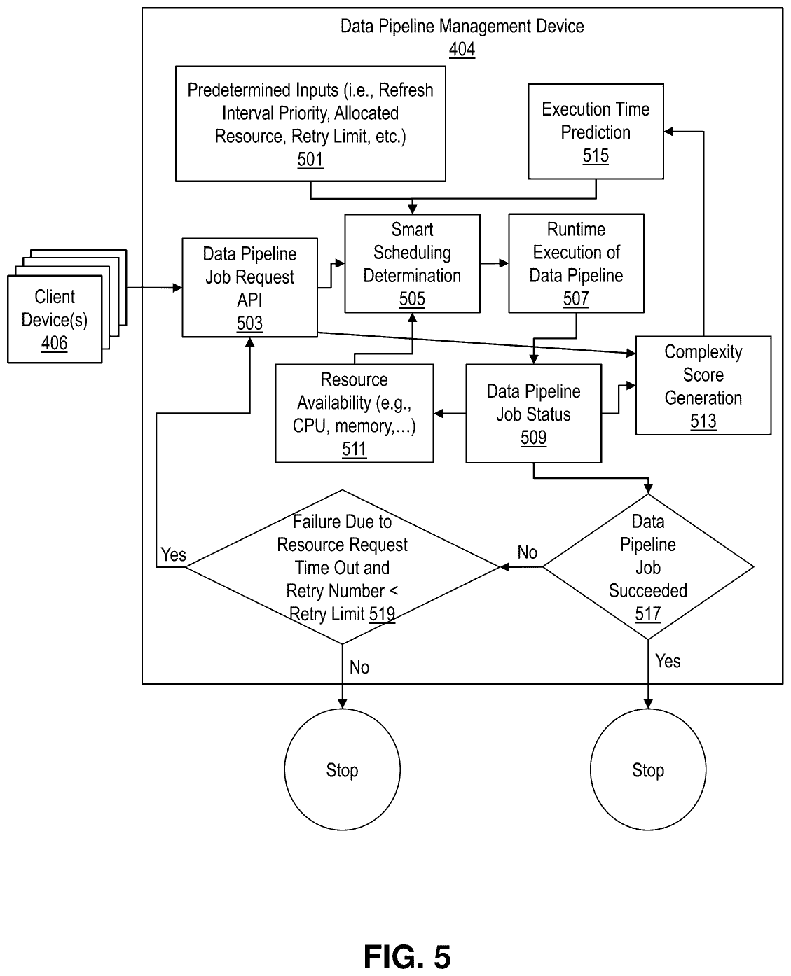

FIG. 5 shows a flowchart of objects and steps taken of an exemplary method in accordance with aspects of the present invention. Steps of the method may be carried out in the environment of FIG. 4 and are described with reference to elements depicted in FIG. 4. In embodiments, the data pipeline management device 404 receives various predetermined inputs in step 501. The predetermined inputs in step 501 may be known from devices associated with the execution of the data pipelines or may be input by a user of the data pipeline management device 404. These predetermined inputs in step 501 may include a refresh interval priority, allocated resources to execute the data pipelines, a retry limit, etc. In embodiments, the client devices 406 may send the data pipeline job requests to the data pipeline management device 404. The data pipeline job requests may be received by a data pipeline job request API in step 503. The data pipeline job requests may include registration information for each data pipeline job and are analyzed for use by the complexity score generator 420.

In embodiments of FIG. 5, in step 515, the generated complexity score is provided to the execution time predictor module 421 for use in execution time prediction. The execution time predictor module 421 utilizes ML modeling with various inputs, including the complexity score, to predict execution times for various data pipeline jobs. In step 505, the predicted execution times are utilized by the smart scheduling module 422 for smart scheduling determination.

In embodiments of FIG. 5, in step 505, the data pipeline job request may be sent directly to the smart scheduling module 422 for smart scheduling determination. At step 505, the data pipeline job is prioritized for scheduling. At step 507, runtime execution of the data pipeline occurs based on the schedule using the resources of the data pipeline management device 404. At step 509, the data pipeline execution is completed. Further, at step 517, a status is determined for whether the data pipeline job has succeeded. At step 513, the data pipeline job status may be sent to the complexity score module 420 for a complexity score generation. The data pipeline job status information may be utilized in runtime analysis scoring. Further, in embodiments, the data pipeline job status information may be updated in the static analysis score updating (e.g., changes in weighting of significant patterns). Further, in step 511, based on the data pipeline job status, the resource allocation of the data pipeline management device 404 may be updated. Further, once a data pipeline job is completed, the CPU and Memory resources may be freed for new data pipeline jobs.

At step 517, in response to a determination that the data pipeline job status has succeeded, the process may end. At step 519, in response to a determination that the data pipeline job status has not succeeded, the job may continue to determine whether the failure of the data pipeline job is due to a resource request time out and a retry limit having been met. If both are true (i.e., the resource request has timed out and the retry limit has been met), then the job is ended. If at least one of the resource request being timed out and the retry limit being met are false, the data pipeline job may be returned to the data pipeline job request API in step 503 for re-submittal to the smart scheduling module 422.

FIG. 6 shows a chart of a smart scheduler prioritization of data pipelines of an exemplary method in accordance with aspects of the present invention. In embodiments, the chart shown in FIG. 6 is generated by the smart scheduling module 422. The data pipelines P1-P11 are shown in a rectangular prism with axes representing the estimated resource requirements of each data pipeline. In particular CPU, Memory, and SLA Time allocations are organized such that data pipelines with higher priority scores are stacked one over another to optimally utilize the predetermined resource allocations available to the data pipeline management device 404. Thus, as shown in FIG. 6, data pipelines P1-P6, P8, and P12 are initially executed at the same time. When data pipeline P2 completes, data pipelines P7 and P10 are executed. Further, when data pipelines P7 and P10 are complete, the data pipeline P11 is executed.

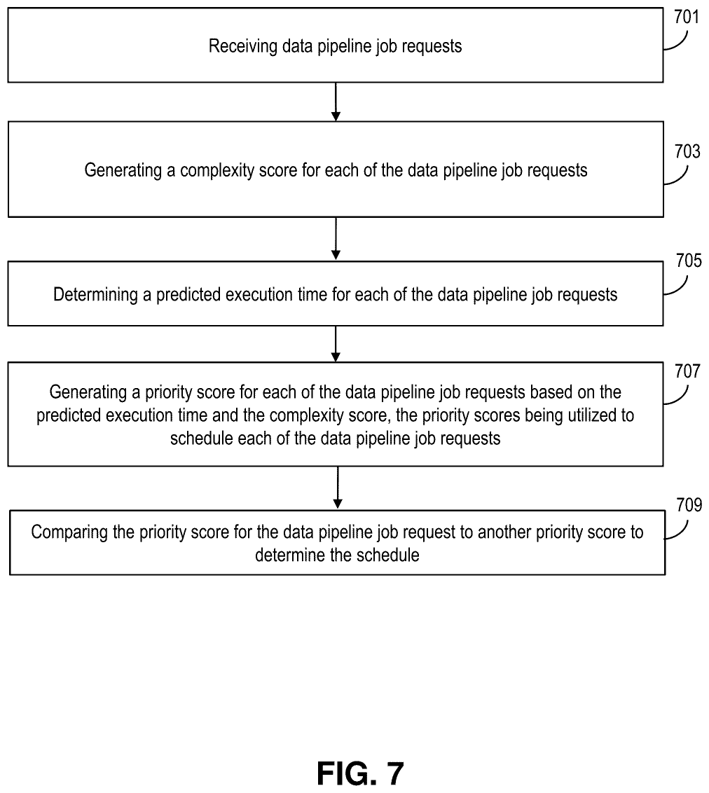

FIG. 7 shows a flowchart of an exemplary method in accordance with aspects of the present invention. Steps of the method may be carried out in the environment of FIG. 4 and are described with reference to elements depicted in FIG. 4.

In embodiments, at step 701, the system (e.g., data pipeline management device 404 of FIG. 4) receives data pipeline job requests. At step 703, the system generates a complexity score for each of the data pipeline job requests. In embodiments, at step 705, the generated complexity scores are utilized for determining a predicted execution time for each of the data pipeline job requests. At step 707, the predicted execution time and generated complexity score are utilized to generate a priority score. The priority score is utilized to schedule the data pipeline job requests and optimize use of allocated resources of the data pipeline management device 404. At step 709, the priority score is compared to another priority score to determine a schedule for the data pipeline job requests. For example, higher priority scores may be scheduled earlier to meet the SLA terms and resource requirements.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computing device, a data pipeline job request;
generating, by the computing device, a complexity score for the data pipeline job request;
determining, by the computing device, a predicted execution time for the data pipeline job request;
generating, by the computing device, a priority score for the data pipeline job request based on the predicted execution time and the generated complexity score; and
comparing, by the computing device, the priority score for the data pipeline job request to another priority score to determine a schedule for the data pipeline job request.

2. The computer-implemented method of claim 1, wherein the complexity score of the data pipeline job request includes a static analysis score and a runtime analysis score.

3. The computer-implemented method of claim 2, wherein the static analysis score includes a count of significant patterns and weighting of a subset of the significant patterns of the data pipeline job request.

4. The computer-implemented method of claim 1, wherein the complexity score of the data pipeline job request is based on a dimensionality reduction technique.

5. The computer-implemented method of claim 2, wherein the runtime analysis score is calculated at an end of an execution of the data pipeline job request, and the runtime analysis score includes a count of dominant data pipeline execution profiles and actual spent resources.

6. The computer-implemented method of claim 3, wherein the significant patterns of the data pipeline job include at least one of:
a shuffling or sorting of data in the data pipeline job,
a de-duplication of the data,
a regular expression search of text in the data,
input-output and/or read-write of the data,
aggregation of the data, and
serverless function on the data.

7. The computer-implemented method of claim 1, wherein the predicted execution time is determined by utilizing a machine learning model, the machine learning model is trained with pipeline information of historical data pipeline jobs.

8. The computer-implemented method of claim 7, wherein the pipeline information comprises information of a data pipeline of the historical data pipeline jobs including at least one of:
a pipeline name of a data pipeline,
a timestamp of the data pipeline,
a type of the data pipeline,
a resource requirement needed to execute the data pipeline,
a time to live,
an initial timestamp of a data pipeline job,
a predicted execution time of the data pipeline, and
the complexity score of the data pipeline.

9. The computer-implemented method of claim 1, wherein the priority score is further based on a resource requirement needed to execute the data pipeline of the data pipeline job request.

10. The computer-implemented method of claim 1, wherein the priority score is further based on a service level agreement (SLA) time for the data pipeline job request to prevent an SLA breach.

11. The computer-implemented method of claim 1, further comprising:
providing the data pipeline job request to a reinforcement learning model for the schedule.

12. The computer-implemented method of claim 1, wherein the computing device includes software providing a cloud-based service.

13. A computer program product comprising one or more computer readable storage media having program instructions collectively stored on the one or more computer readable storage media, the program instructions executable to:
receive a data pipeline job request;
generate a complexity score for the data pipeline job request;
determine a predicted execution time for the data pipeline job request;
generate a priority score for the data pipeline job request based on the predicted execution time and the generated complexity score; and
compare the priority score the data pipeline job request to another priority score to determine a schedule for the data pipeline job request,
wherein the predicted execution time is determined by utilizing a machine learning model trained with pipeline information of historical data pipeline jobs.

14. The computer program product of claim 13, wherein the complexity score of the data pipeline job request includes a static analysis score and a runtime analysis score.

15. The computer program product of claim 14, wherein the static analysis score includes a count of significant patterns and weighting of a subset of the significant patterns of the data pipeline job request.

16. The computer program product of claim 14, wherein the runtime analysis score is calculated at an end of an execution of the data pipeline job request, the runtime analysis score includes a count of dominant data pipeline execution profiles and actual spent resources.

17. A system comprising:
a processor, a computer readable memory, one or more computer readable storage media, and program instructions collectively stored on the one or more computer readable storage media, the program instructions executable to:
receive a plurality of data pipeline job requests;
generate a complexity score for each of the data pipeline job requests;
determine a predicted execution time for each of the data pipeline job requests;
generate a priority score for each of the data pipeline job requests based on the predicted execution time and the generated complexity score; and
compare the priority score for each the data pipeline job requests to another priority score to determine a schedule for each of the data pipeline job requests.

18. The system of claim 17, wherein the complexity score of each of the data pipeline job requests includes a static analysis score and a runtime analysis score.

19. The system of claim 18, wherein the static analysis score includes a count of significant patterns and weighting of a subset of the significant patterns of a data pipeline job of the data pipeline job requests.

20. The system of claim 18, wherein the runtime analysis score is calculated at an end of an execution of a data pipeline job of the data pipeline job requests, and the runtime analysis score includes a count of dominant data pipeline execution profiles and actual spent resources.
